(19) United States
(12) Patent Application Publication
(10) Pub. No.: US 2012/0168058 A1
(43) Pub. Date: Jul. 5, 2012

(54) CURVED DISPLAY PANEL MANUFACTURING METHOD

(75) Inventors: Yong Beom Kim, Incheon (KR); Woon Yong Park, Suwon-si (KR)

(73) Assignee: TOVIS CO., LTD., Incheon (KR)

(21) Appl. No.: 13/394,585

(22) PCT Filed: Sep. 1, 2010
(86) PCT No.: PCT/KR10/05913

§ 371 Date: Mar. 7, 2012

(30) Foreign Application Priority Data
Sep. 18, 2009 (KR) 10-2009-0088292

(51) Int. Cl. B32B 17/06

(52) U.S. Cl. 156/101

(57) ABSTRACT

The present invention relates to a method for manufacturing a curved display panel. The method for manufacturing a curved display panel using a lower substrate and an upper substrate made of glass and opposite each other, and a liquid crystal layer formed between the lower substrate and the upper substrate, comprises: a step of cutting out portions of outer surfaces of the lower substrate and the upper substrate such that the thicknesses of the substrates are reduced to a preset level; and a step of bending the cut lower substrate and the cut upper substrate into a desired curved shape, and forming transparent polymer layers, having shapes identical to the desired curved shape, onto outer surfaces of the substrates, respectively, or attaching transparent substrates, which are prefabricated into shapes identical to the desired curved shape, onto outer surfaces of the substrates, respectively.

### TECHNICAL FIELD

The present invention relates to a display panel manufacturing method for manufacturing a display panel in a curved shape.

### BACKGROUND ART

As display technology makes advances, various kinds of display devices are being developed and used. From among these display devices, there is a liquid crystal display device to display an image using liquid crystals.

A liquid crystal panel of a general liquid crystal display (LCD) includes two substrates and a liquid crystal layer having dielectric anisotropy interposed between the two substrates. The liquid crystal panel applies an electric field to the liquid crystal layer and adjusts an intensity of the electric field to adjust transmittance of light passing through the liquid crystal layer, thereby obtaining a desired image. Such an LCD is a representative one of flat panel displays (FPDs) which are handy to carry. From among various LCDs, a TFT-LCD using thin film transistors (TFTs) as switching elements is mainly used.

From among the two substrates of the liquid crystal panel which are opposite each other, a plurality of display signal lines, i.e., gate lines and data lines, a plurality of thin film transistors and pixel electrodes are formed on the lower substrate, and color filters and a common electrode are formed on the upper substrate.

Such a liquid crystal panel is generally manufactured in a flat shape. Therefore, if a curved display is required, the general flat liquid crystal panel is not used.

In order to solve such a problem, a flexible liquid crystal panel which employs substrates formed of a flexible material rather than glass substrates used in a general liquid crystal panel so as to be curved if external force is applied to the flexible liquid crystal panel has been developed.

However, the above conventional flexible liquid crystal panel has a difficult manufacturing process and high manufacturing costs.

### DISCLOSURE

### Technical Problem

Therefore, the present invention has been made in view of the above problems, and it is an object of the present invention to provide a display panel manufacturing method for simply manufacturing a curved display panel using a liquid crystal panel employing conventional glass substrates.

### Technical Solution

In accordance with an aspect of the present invention, the above and other objects can be accomplished by the provision of a display panel manufacturing method in which a display panel in a desired curved shape is manufactured using a flat liquid crystal panel with a lower substrate and an upper substrate formed of glass and opposite each other and a liquid crystal layer formed between the lower substrate and the upper substrate, including removing parts of the outer surfaces of the lower substrate and the upper substrate to reduce the lower substrate and the upper substrate to a predetermined thickness, and bending the reduced lower and upper substrates in the desired curved shape and then forming a transparent polymer layer in the same shape as the desired curved shape on each of the outer surfaces of the lower and upper substrates or adhering a transparent substrate manufactured in advance in the same shape as the desired curved shape to each of the outer surfaces of the lower and upper substrates.

The predetermined thickness may be within the range of 50 to 150 μm.

### Advantageous Effects

The present invention provides a display panel manufacturing method in which a display panel in a curved shape may be simply manufactured by removing parts of the outer surfaces of a lower substrate and an upper substrate of a general liquid crystal panel to reduce the thickness of each of the lower and upper substrates, bending the lower and upper substrates in the curved shape, and then forming a transparent polymer layer on each of the outer surfaces of the lower substrate and the upper substrate or adhering a transparent substrate to each of the outer surfaces of the lower substrate and the upper substrate under the condition that the lower and upper substrates are bent in the curved shape.

### DESCRIPTION OF DRAWINGS

FIG. 1 is a schematic perspective view of a liquid crystal panel to which a display panel manufacturing method in accordance with one embodiment of the present invention is applicable; and

FIG. 2 is a view illustrating the display panel manufacturing method in accordance with the embodiment of the present invention.

### BEST MODE

Hereinafter, embodiments of the present invention will be described in more detail with reference to the accompanying drawings.

In the drawings, the thickness of each of several layers and regions is exaggerated for convenience of description and clarity. Wherever possible, the same reference numbers will be used throughout the drawings to refer to the same or like parts. It will be understood that when an element is referred to as being ‘on’ or “under” another element, it can be directly on/under the element, and one or more intervening elements may also be present. However, when an element is referred to as being directly ‘on’ or ‘under’ another element, one or more intervening elements are not present.

A display panel manufacturing method in accordance with one embodiment of the present invention is a method for manufacturing a display panel in a curved shape using a general liquid crystal panel.

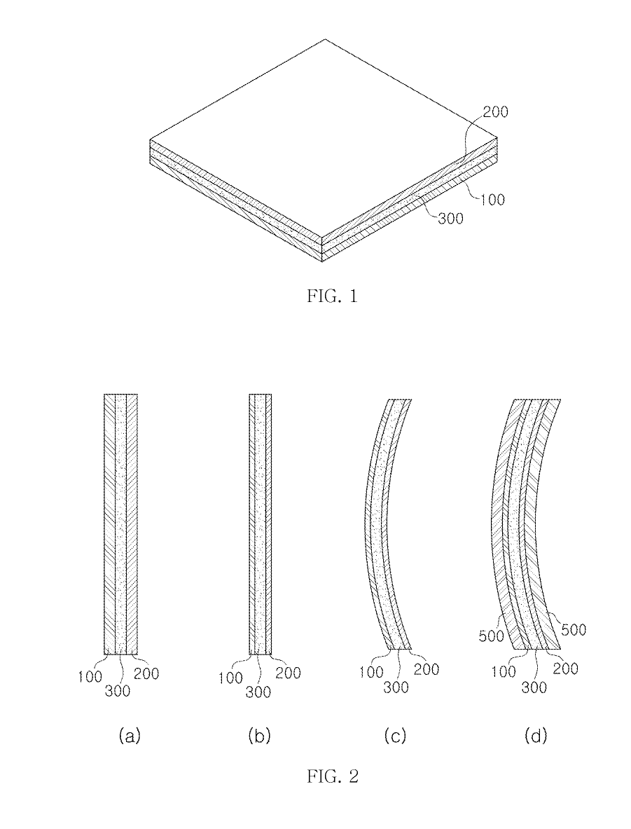

With reference to FIG. 1, the general liquid crystal panel includes a lower substrate 100 and an upper substrate 200 which are formed of glass and are opposite each other, and a liquid crystal layer 300 formed between the lower substrate 100 and the upper substrate 200 and including liquid crystal molecules oriented vertically or horizontally with respect to the two substrates 100 and 200. The lower substrate 100 is referred to as a thin film transistor array substrate, and the upper substrate 200 is referred to as a color filter array substrate.

A sealant (not shown) formed of a material to bond the two substrates 100 and 200, defining a part filled with liquid crystals, and preventing leakage of the liquid crystals may be formed at the edge of each of the two substrates 100 and 200, and polarizing plates to polarize light may be attached to the outer surfaces of the two substrates 100 and 200.

Hereinafter, the display panel manufacturing method for manufacturing a display panel in a curved shape in accordance with the embodiment of the present invention will be described with reference to FIG. 2.

FIG. 2(a) is a side view of a general liquid crystal panel, and, in accordance with the present invention, parts of the outer surfaces of the lower substrate 100 and the upper substrate 200 are removed to be reduced to a predetermined thickness, as shown in FIG. 2(b). Here, the predetermined thickness may have a value within the range of 50 to 150 μm.

That is, the parts of the outer surfaces of the lower substrate 100 and the upper substrate 200 formed of glass are removed such that the thickness of each of the lower substrate 100 and the upper substrate 200 is reduced to the predetermined thickness. Here, the lower substrate 100 and the upper substrate 200 are removed through a conventionally known method, for example, a mechanical polishing method or an etching method using an etching solution.

The reason why the thickness of each of the lower substrate 100 and the upper substrate 200 after removal of the parts of the outer surfaces of the lower substrate 100 and the upper substrate 200 has a value within the range of 50 to 150 μm is to bend the lower substrate 100 and upper substrate 200 without breakage. That is, if the thickness of each of the lower substrate 100 and the upper substrate 200 after removal of the parts of the outer surfaces of the lower substrate 100 and the upper substrate 200 is smaller than 50 μm or greater than 150 μm, the lower substrate 100 and the upper substrate 200 may be easily broken or are not bent during the bending process of the lower substrate 100 and the upper substrate 200.

After the lower substrate 100 and the upper substrate 200 are reduced to the predetermined thickness, the lower substrate 100 and the upper substrate 200 are bent in a desired curved shape, as shown in FIG. 2(c).

Further, a transparent polymer layer 500 in the same shape as the desired curved shape may be respectively formed on each of the outer surfaces of the lower substrate 100 and the upper substrate 200 under the condition that the lower substrate 100 and the upper substrate 200 are bent in the desired curved shape, as shown in FIG. 2(d). That is, the transparent polymer layer 500 may be formed by applying a liquid transparent polymer to the outer surfaces of the lower substrate 100 and the upper substrate 200 under the condition that the lower substrate 100 and the upper substrate 200 are bent in the desired curved shape and then hardening the liquid transparent polymer. The transparent polymer layer 500 may be formed by fixing the bent lower and upper substrates 100 and 200 within a mold, inserting the polymer into both sides of the mold, and then hardening the polymer. During a process of hardening the liquid transparent polymer, the polymer is adhered to the outer surfaces of the lower substrate 100 and the upper substrate 200. Therefore, when the liquid transparent polymer is hardened, the lower substrate 100, the upper substrate 200 and the transparent polymer layers 500 are maintained in the desired curved shape. Here, the transparent polymer may be a random transparent or semi-transparent polymer, such as transparent UV resin.

Instead of the transparent polymer layer 500, a transparent substrate manufactured in advance in the same shape as the desired curved shape may be adhered to each of the outer surfaces of the lower substrate 100 and the upper substrate 200. Here, the transparent substrate may be a substrate formed of a transparent or semi-transparent material, such as glass, a synthetic resin, etc. For example, the transparent substrate may be adhered to each of the outer surfaces of the lower substrate 100 and the upper substrate 200 by an optically clear adhesive (OCA).

The lower substrate 100 and the upper substrate 200 may be kept in the desired curved shape by forming the transparent polymer layer on each of the outer surfaces of the lower substrate 100 and the upper substrate 200 or adhering the transparent substrate to each of the outer surfaces of the lower substrate 100 and the upper substrate 200 under the condition that parts of the outer surfaces of the lower substrate 100 and the upper substrate 200 are removed to reduce the thickness of each of the lower and upper substrates 100 and 200 and then the lower substrate 100 and the upper substrate 200 are bent in the desired curved shape, as described above.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention provides a display panel manufacturing method which is applicable to manufacturing of a display panel.

We claim:

1. A display panel manufacturing method in which a display panel in a desired curved shape is manufactured using a flat liquid crystal panel with a lower substrate and an upper substrate formed of glass and opposite each other and a liquid crystal layer formed between the lower substrate and the upper substrate, comprising:
removing parts of the outer surfaces of the lower substrate and the upper substrate to reduce the lower substrate and the upper substrate to a predetermined thickness; and
bending the reduced lower and upper substrates in the desired curved shape, and then forming a transparent polymer layer in the same shape as the desired curved shape on each of the outer surfaces of the lower and upper substrates or adhering a transparent substrate manufactured in advance in the same shape as the desired curved shape to each of the outer surfaces of the lower and upper substrates.

2. The display panel manufacturing method according to claim 1, wherein the predetermined thickness is within the range of 50 to 150 μm.
